(19) United States
(12) Patent Application Publication
(10) Pub. No.: US 2009/0300016 A1
(43) Pub. Date: Dec. 3, 2009

(54) TECHNIQUES FOR FILTERING DATA

(75) Inventor: Nathan Kile, JR., Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/131,716

(22) Filed: Jun. 2, 2008

(51) Int. Cl. G06F 17/30

(52) U.S. Cl. 707/7; 707/E17.001

(57) ABSTRACT

Techniques for obtaining filtering criteria used to filter a data set are described. A user interface includes a plurality of filters having an associated hierarchy. The user interface includes user interface elements corresponding to the plurality of filters with a structure in accordance with the associated hierarchy. Filtering criteria includes active filters based on selected filter values, filter state indicators, and the associated hierarchy. Enabling a parent filter causes an enabled child filter to be in the filtering criteria. Disabling the parent filter causes the child filter to be omitted from the filtering criteria. In response to a change in filtering criteria, the filtered data set may be automatically updated. User interface elements and associated filters are revealed in accordance with the hierarchy. The user interface may be customizable. Filter selections and filter state information from a session may be used to initialize a subsequent user interface session.

### BACKGROUND

A data set may be filtered using criteria specified by a user. The user may be presented with a variety of different user interface elements in connection with specifying the criteria. For example, the interface may include a form with multiple text boxes where the user may manually enter one or more keywords, select one or more filtering terms using menus and/or radio buttons, specify logical combinations of terms used for filtering, and the like. The interface may provide the user with multiple options each specifying different filtering criteria. The user may be required to determine which of the multiple options are to be used in combination when filtering the data set. As such, a user may find the interface to be complex and present difficulties in connection with specifying the criteria used to filter the data set.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Techniques are described for obtaining filtering criteria used to filter a data set. A user interface includes a plurality of filters having an associated hierarchy. Filtering criteria includes filters determined as active based on selected filter values, filter state indicators, and the associated hierarchy. Enabling a parent filter causes an enabled child filter to be in the filtering criteria. Disabling the parent filter causes the child filter to be omitted from the filtering criteria. In response to a change in filtering criteria, the filtered data set may be automatically updated. User interface elements and associated filters may be revealed in accordance with the hierarchy. The user interface may be customizable. Filter selections and filter state information from a session may be used to initialize a subsequent user interface session.

### DESCRIPTION OF THE DRAWINGS

Features and advantages of the present invention will become more apparent from the following detailed description of exemplary embodiments thereof taken in conjunction with the accompanying drawings in which:

FIG. 1 is an example an environment that may be utilized in an embodiment in connection with the techniques described herein;

FIG. 2 is an example of components that may be included in an embodiment and used in connection with performing the techniques herein;

FIG. 3 is another example of components that may be included in an embodiment and used in connection with performing the techniques herein;

FIGS. 4-10 are examples illustrating user interface elements that may be displayed in an embodiment in connection with performing the techniques herein;

FIG. 11 is an example representation of a hierarchy that may be used in an embodiment in connection with performing the techniques herein;

FIGS. 12-16 are examples illustrating information that may stored for nodes in the hierarchy and associated structures in an embodiment performing the techniques herein; and

FIG. 17 is a flowchart of processing steps that may be performed in an embodiment in connection with the techniques described herein.

### DETAILED DESCRIPTION

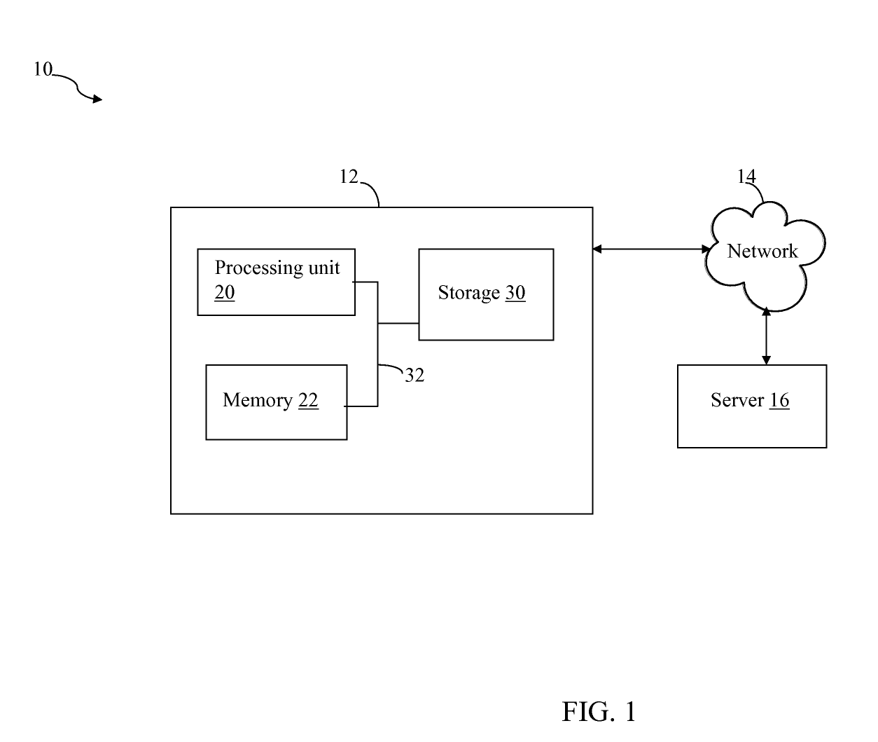

Referring to FIG. 1, illustrated is an example of a suitable computing environment in which embodiments utilizing the techniques described herein may be implemented. The computing environment illustrated in FIG. 1 is only one example of a suitable computing environment and is not intended to suggest any limitation as to the scope of use or functionality of the techniques described herein. Those skilled in the art will appreciate that the techniques described herein may be suitable for use with other general purpose and specialized purpose computing environments and configurations. Examples of well known computing systems, environments, and/or configurations include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The techniques set forth herein may be described in the general context of computer-executable instructions, such as program modules, executed by one or more computers or other devices. Generally, program modules include routines, programs, objects, components, data structures, and the like, that perform particular tasks or implement particular abstract data types. Typically the functionality of the program modules may be combined or distributed as desired in various embodiments.

Included in FIG. 1 are a computer 12, a network 14, and a server 16. The computer 12 may include a standard, commercially-available computer or a special-purpose computer that may be used to execute one or more program modules. Described in more detail in following paragraphs and figures are program modules that may be executed by the computer 12 in connection with filtering a data set using the techniques described herein. The computer 12 may operate in a networked environment and communicate with other computers, such as a server 16, as well as others not shown in FIG. 1.

It will be appreciated by those skilled in the art that although the computer 12 is shown in the example as communicating in a networked environment, the computer 12 may communicate with other components utilizing different communication mediums. For example, the computer 12 may communicate with one or more components utilizing a network connection, and/or other type of link known in the art including, but not limited to, the Internet, an intranet, or other wireless and/or hardwired connection(s).

As illustrated in FIG. 1, the computer 12 may include one or more processing units 20, memory 22, storage 30, and a system bus 32 used to facilitate communications between the components of the computer 12, as well as other components not illustrated in FIG. 1.

Depending on the configuration and type of computer 12, memory 22 may be volatile (such as RAM), non-volatile (such as ROM, flash memory, etc.) or some combination of the two. Additionally, the computer 12 may also have additional storage (removable and/or non-removable) including, but not limited to, USB devices, magnetic or optical disks, or tape. Such additional storage is illustrated in FIG. 1 by storage 30. The storage 30 may include one or more removable and non-removable storage devices having associated computer-readable media that may be utilized by the computer 12. The storage 30 in one embodiment may include a hard disk and/or CD-ROM drive. By way of example, and not limitation, memory 22 and storage 30 are examples of computer readable media. Computer readable media includes volatile and nonvolatile, removable and non-removable media implemented in any method or technology for storage of information such as computer readable instructions, data structures, program modules or other data. Computer readable media includes, but is not limited to, RAM, ROM, EEPROM, flash memory or other memory technology, CD-ROM, (DVD) or other optical storage, magnetic cassettes, magnetic tape, magnetic disk storage or other magnetic storage devices, or any other medium which can be used to store the desired information and which can accessed by the computer 12. The foregoing media typically embodies computer readable instructions, data structures, program modules or other data.

In one embodiment as described herein, the computer 12 may operate in a networked environment as illustrated in FIG. 1 using logical connections to remote computers, such as the server 16, through a network. One or more software modules and/or data files may be included in storage 30 of the computer 12. During operation of the computer 12, one or more of these modules included in the storage 30 may also reside in a portion of memory 22, such as, for example, RAM for controlling the operation of the computer 12.

The server 16 may represent a server computer system connected to the network 14. The server computer system may include software modules to service requests and one or more processors, memory, storage, and the like, similar to that as described herein with respect to the computer 12. As will be described in more detail in following paragraphs, the techniques herein may be used in an embodiment in which the computer 12 operates standalone without connectivity to the server 16. In another embodiment using the techniques herein also described in following paragraphs, the computer 12 may connect to the server 16 over the network 14.

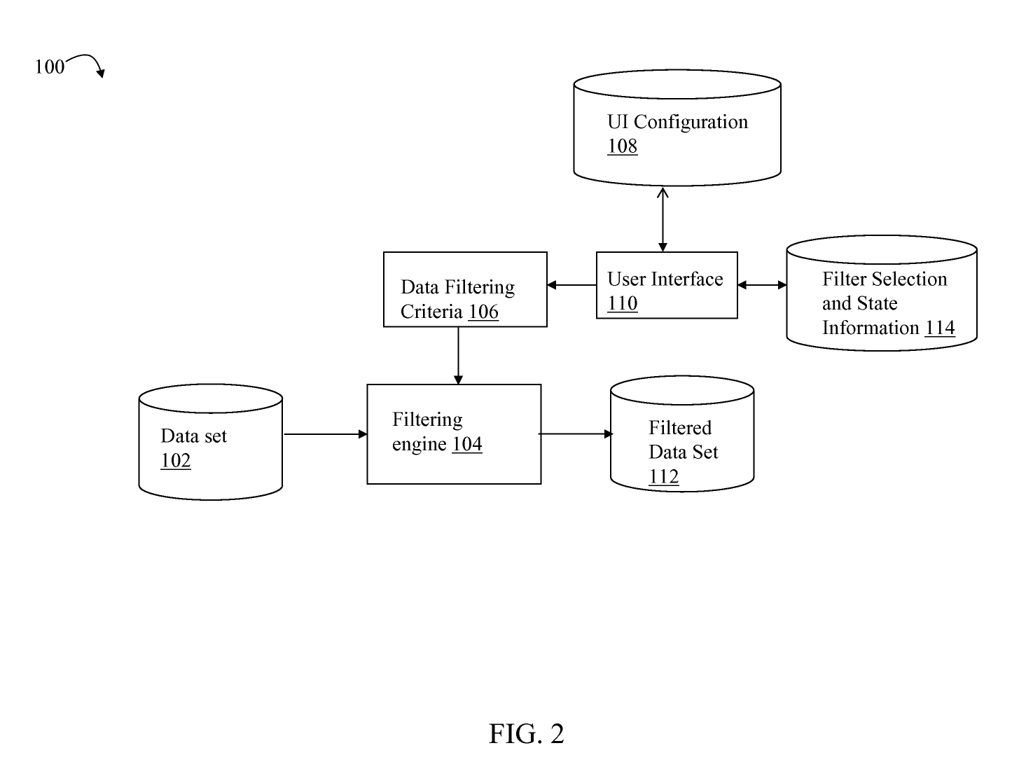

Referring to FIG. 2, shown is an example of software modules and data files that may be included in the computer 12 and used in connection with performing the various embodiments of the techniques described herein. The example 100 of FIG. 2 includes a data set 102, a filtering engine 104, data filtering criteria 106, user interface (UI) 110, a UI configuration file 108, a filtered data set 112 and filter selection and state information 114. As will be described in more detail in following paragraphs, data filtering criteria 106 may be obtained using the UI 110. The UI 110 may display possible or candidate filtering criteria from which user selections are made to determine the data filtering criteria 106 used to generate the filtered data set 112. The filtering engine 104 may receive as an input the data set 102 and generate a filtered data set 112 in accordance with the data filtering criteria 106.

The UI 110 may have a configuration specified in accordance with the UI configuration file 108. The UI configuration file 108 may describe information used to customize the UI content displayed to a user. As an example in connection with obtaining the data filtering criteria 106, the UI 110 may include software that displays various user interface elements from which a user may make various selections. The UI 110 may include software which then generates the data filtering criteria 106 in accordance with user selections. The user interface elements, such as menus, radio buttons, and the like, may be used to display different candidate filtering criteria from which a user makes selections resulting in the data filtering criteria 106. The user may customize the candidate filtering criteria included in the user interface elements and such selected customizations may be described in the UI configuration file 108. An embodiment of the UI 110 may present to a user candidate data filtering criteria associated with numerous categories of filters. The file 108 may include a number of selected filter categories of particular interest to the user. The categories specified in the UI configuration file 108 may determine the content and associated structure of candidate filtering criteria when populating the user interface elements displayed at a point in time. For example, a user may be interested in filtering data set 102 to produce a filtered data set 112 including information relevant only to sports, animals, dining and entertainment, computer-related topics, and the like. The user may customize the candidate filtering criteria displayed by selecting filter categories of interest and include these categories in the UI configuration file 108. The UI 110 may then populate the user interface elements with content in accordance with the selected filter categories. The UI 110, or other software, may include functionality which allows a user to browse and select from the available filter categories and then accordingly update the UI configuration file 108. The file 108 may be subsequently used by the UI 110 to populate the displayed user interface including the candidate filtering criteria from which the user may make selections to specify the criteria 106 used in generating the filtered data set 112. It should be noted that an embodiment may include a default UI configuration file 108 specifying default filter categories and/or other information used in populating the user interface elements displayed by the UI 110. The foregoing default categories may be used if there are no customized filter category selections.

It should be noted that an embodiment may also use other modules, data files, and the like, not illustrated in the example 100. For example, the UI 110 and/or engine 104 included in an embodiment may utilize other inputs and outputs not illustrated in the example 100.

The filter selection and state information 114 may be used to define an initial or starting state for the UI 110. The filter selection and state information 114 may describe various selected filter values and filter states indicating whether filters are enabled or disabled. During operation of the UI 110 in a first session at a first point in time, a user may specify filter values by making menu selections, enable and/or disable various filters, and the like. Software included in the UI 110 may provide for saving information describing the selected filter values and filter states of the first session in the filter selection and state information file 114. At a second later point in time, the information previously saved in the file 114 may be retrieved by the UI 110 to define the initial or start state of the UI 110 for a second session. The foregoing use of the previously saved file 114 may be desirable to allow resuming a previous session without repeating manual processing to select filter values and filter states.

The data set 110, data filtering criteria 106, filtered data set 112, filter selection and state information 114 and UI configuration 108 may have any organization and structure understood and used with the particular components of the example 100 included in an embodiment. For example, the format of the data sets 102 and 112 and criteria 106 may be determined in accordance with the particular filtering engine 104. The engine 104 may be any publicly available, commercially available or customized software that filters the data set 102.

During operation, a user makes selections from the interface displayed using the UI 110. A user interaction related to a filter selection or change in filter state causing a filter to be enabled or disabled may automatically trigger the generation of revised data filtering criteria 106 resulting in invocation of the engine 104 and generation of a revised filtered data set 112. In other words, the filtered data set 112 may be regenerated automatically in response to user interactions causing the data filtering criteria 106 to be updated. Such user interactions may include, for example, selecting a filter value for a filter from a menu, and enabling or disabling one or more filters.

In accordance with the techniques described herein as set forth in following paragraphs, software of the UI 110 may provide the user with one or more filters in a structured and organized manner. The techniques herein navigate the user through a hierarchical arrangement of user interface elements to assist in specification of data filtering criteria. The user may be presented with user interface elements populated with candidate filtering criteria customized for the particular user. The filtering criteria used at a point in time to generate the filtered data set may be based on current filter value selections and filter state settings. An updated filtered data set may be automatically generated when there is a change to the selected filtering criteria. Such a change may be caused by selection of a filter value or enabling/disabling one or more filters at one or more levels in the hierarchical arrangement of user interface elements.

Although the components of the example 100 of FIG. 2 may be included in a single computer system, such as the computer 12, the components may be included on different computer systems and operate in accordance with the techniques described herein. For example, a user on the computer 12 may connect to the server 16 using a web service. The user may have an account on the server 16. In such an embodiment, components of FIG. 2 may be included on the server 16. In such an embodiment in which the user connects to the server to utilize the techniques herein, a portion of the components in FIG. 2 may also be stored on the computer 12. For example, the UI configuration 108 and/or filter selection and state information 114 may be stored in any one or more different forms on the computer 12 at a first point in time for a first session, and then used during a second session when the user reconnects to the server 16 to filter the same or a different data set. The foregoing are just some variations as to where the different components used in providing the functionality described herein may reside in an embodiment.

It should be noted that the techniques herein may be used alone, or in combination with additional filtering. The additional filtering may be performed prior to using the techniques herein and used to generate the data set 102. For example, the data set 102 may be generated as a result of an initial query performed of a database using a database query engine, of web pages using a search engine, and the like. In this example, the techniques herein may be used in connection with further refining or filtering the data set previously generated as a result of the initial query. The additional filtering may also be performed in a processing stage after using the techniques herein so that the filtered data set 112 may be used as an input to the additional filtering.

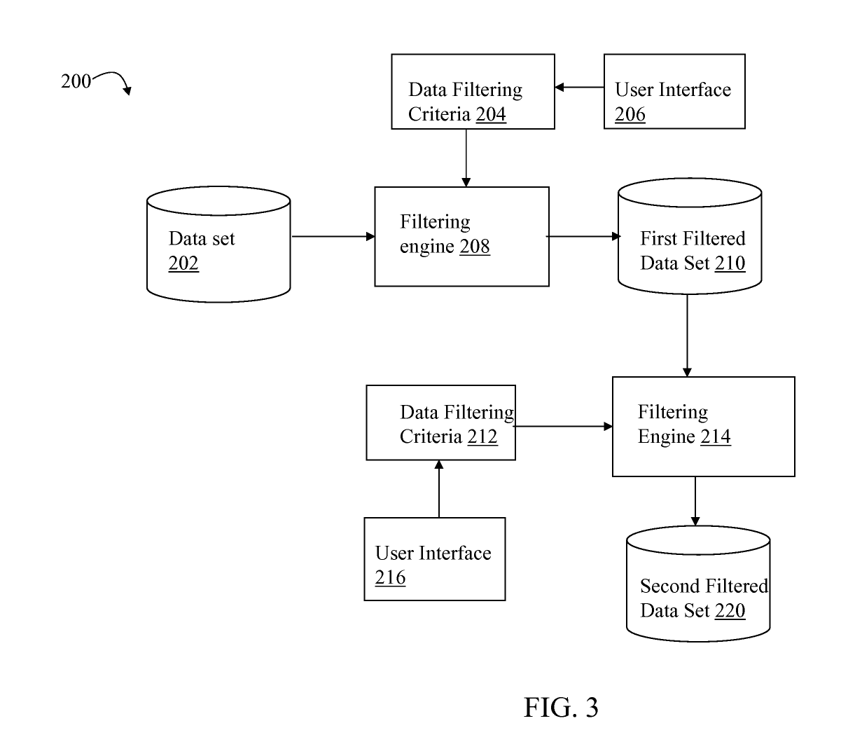

Referring to FIG. 3, shown is another example of components that may be included in an embodiment using the techniques herein. The example 200 illustrates a two-stage data filtering process. The first stage of the filtering process is illustrated in the example 200 using elements 202, 204, 206, 208 and 210. The second stage of the filtering process is illustrated in the example 200 using elements 210, 214, 212, 216 and 220. It should be noted that the UI configuration 108 and filter selection and state information 114 are omitted from the example 200 for simplicity of illustration but may be used with the UI 206 and UI 216 as described herein in connection with FIG. 2. In the first stage, data set 202 is input to the filtering engine 208 which generates the first filtered data set 210 in accordance with the data filtering criteria 204. As described in connection with the example 100, the UI 206 may be used to obtain the criteria 204. In the second stage, the first filtered data set 210 is input to the engine 214 which generates the second filtered data set 220 in accordance with the data filtering criteria 212. In connection with the example 200, the techniques herein as may be embodied in the UI 206 and/or 216 may be used to generate, respectively, the data filtering criteria 204 and/or 212.

FIG. 3 illustrates a two stage data filtering process and the techniques herein may be used with determining the filtering criteria associated with either one or both of the stages. More generally, it will be appreciated by those skilled in the art that the techniques herein may be used in connection with any one or more stages associated with a single or a multiple stage filtering process.

What will now be described in connection with subsequent figures is an example of the different user interface elements that may be displayed in connection with the techniques herein to obtain data filtering criteria. It should be noted that the particular user interface elements, such as menus, tabs, buttons, and the like, that may be described in following paragraphs are exemplary for purposes of illustrating the techniques herein. The techniques herein may be used in connection with different user interface elements that may vary with embodiment.

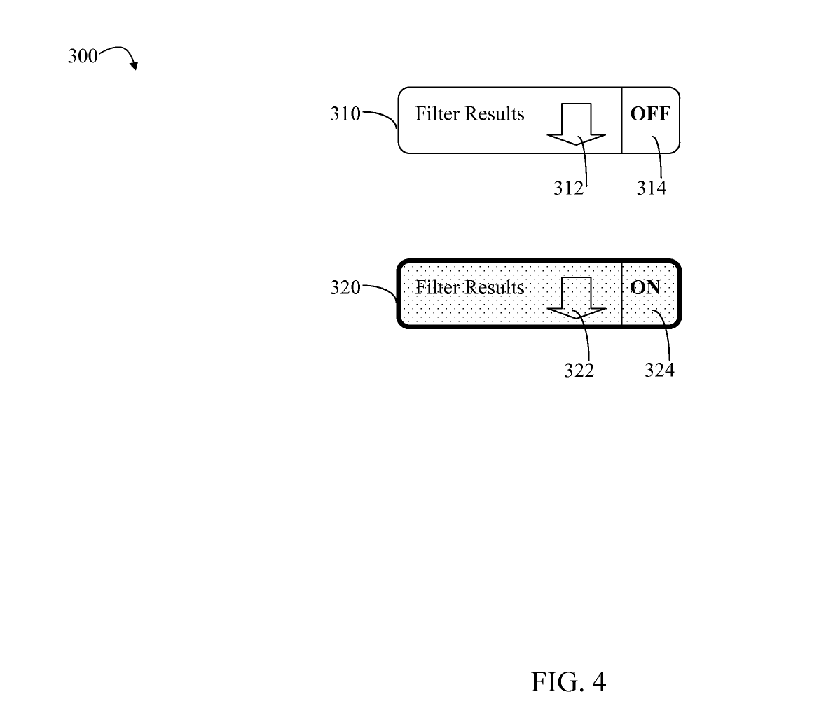

Referring to FIG. 4, shown is an example of a user interface element that may be displayed in an embodiment using the techniques herein. The example 300 illustrates the user interface element in a first state 310 and a second state 320. The user interface element in the first state of 310 may be initially displayed, for example, the first time the software of the UI 110 is utilized in connection with a data set. The element 310 may be displayed in connection with other user interface elements (not shown) such as, for example, where the user may specify the data set to be filtered. The element 310 includes a left portion with an arrow 312 representing a filter viewing state. The filter viewing state indicates whether a filter viewing window is opened to display user interface elements used in specifying the filtering criteria. In the example 300, the current filter viewing state is off as represented by the downward arrow position in 312. As illustrated in subsequent figures, selecting 312 when the current filter viewing state is off causes the filter viewing state to turn on (e.g., as may be represented by the arrow of 312 pointing in an upward vertical direction) and results in additional user interface elements being displayed in a filter viewing window. The portion 314 indicates a current filter state of off (e.g., disabled) which is applied to all filters so that no filters are included in the data filtering criteria. The same user interface element may also be in the second state as illustrated in 320 indicating that the filter state is on (324) and the filter viewing state is off (322, downward arrow) and no filter viewing window is open. A filter state indicator may be associated with a user interface element as illustrated in 314 and 324 and affects what filters are included in the filtering criteria. As described in more detail herein, multiple filter state indicators may be used in determining what filters are currently active and included in the filtering criteria.

The filter state indicator of the example 300 (e.g., having an off state in 314 and an on state in 324) represents a current filter state indicator value associated with a root node in a hierarchical arrangement of nodes corresponding to displayed user interface elements. As will be described in following paragraphs, a filter state indicator associated with a node in the hierarchy may be enabled (e.g., turned on) or disabled (e.g. turned off) to activate or deactivate filters associated with the node and descendants of the node in the hierarchy. As such, the filter state indicator associated with the root node in the hierarchy as illustrated may be disabled to deactivate all filters in the hierarchy. The filter state indicator of the root node may also be enabled to activate any filters in the hierarchy which are enabled and not otherwise deactivated by another node in a same path which is at a higher level in the hierarchy. Determination of what filters are active and included in the filtering criteria applied to a data set is described in more detail in following paragraphs.

A series of exemplary operations will be described to illustrate the techniques herein in connection with a user interface. As a first operation, a user may select 312 to turn on filter viewing which then causes a filter viewing window to be displayed and begin filter navigation.

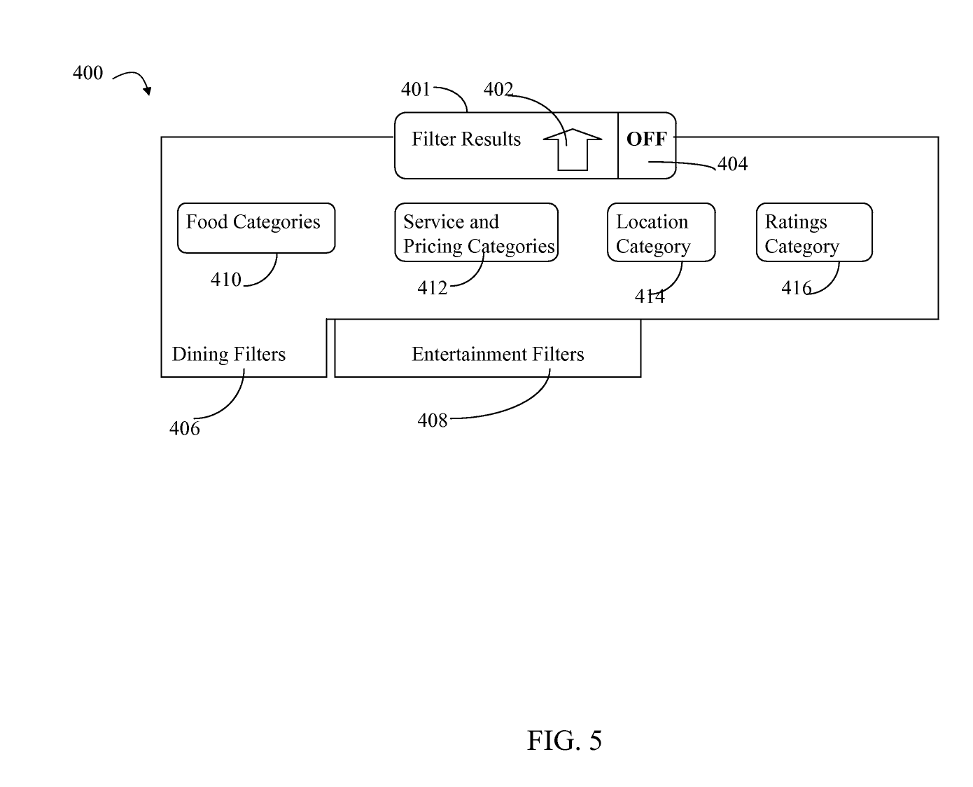

Referring to FIG. 5, shown is an example of the filter viewing window displayed as a result of selecting 312 of FIG. 4 and turning on filter viewing in an embodiment using the techniques herein. The example 400 includes the user interface element 401 with the filter viewing indicator 402 now set to on as indicated by the upward arrow position. The filters are still turned off as indicated by 404.

The example 400 includes a first tab 406 with dining filters and a second tab 408 with entertainment filters. As a default, the first tab may be selected to have a first level of user interface elements associated with dining filters 406 displayed. The tabs 406 and 408 may represent categories of different filters as may be specified in the UI configuration file 108 of FIG. 2. If different categories are included in the file 108, the window may accordingly include other tabs. If the tab 408 is selected, first level user interface elements associated with entertainment filters may be displayed. In response to selecting one of the displayed first level user interface elements, additional user interface elements corresponding to one or more children of the selected first level user interface element are revealed. The additional user interface elements revealed in response to selecting one of the displayed user interface elements are in accordance with a hierarchical arrangement of filters and filter categories associated user interface elements. In this example, the elements 410, 412, 414 and 416 correspond to filter subcategories within the broader filter category indicated by the dining filters tab 408.

In connection with the example 400, a user may make a series of selections to select elements 410, 412, 414, and 416.

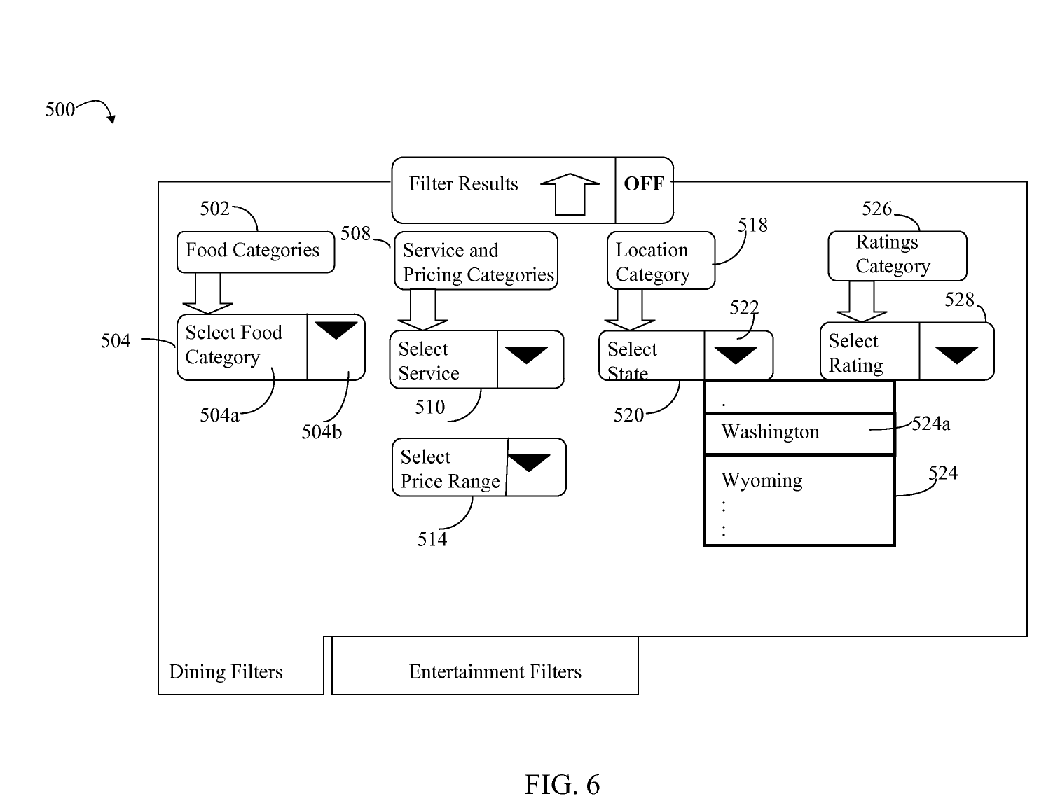

Referring to FIG. 6, shown is an example of a display that may result after selection of elements 410, 412, 414 and 416 of FIG. 5 in an embodiment using the techniques herein. Selection of food categories 502 results in displaying user interface element 504 corresponding to children of 502 in the hierarchy. Element 504 is associated with a filter included in the filter category indicated by 502. Selection of service and pricing categories 508 results in displaying user interface elements 510 and 514 corresponding to children of 508 in the hierarchy. Elements 510 and 514 are associated with filters included in the filter category indicated by 508. Selection of the location category 518 results in displaying user interface element 520 corresponding to children of 518 in the hierarchy. Element 520 is associated with a filter included in the filter category indicated by 518. Selection of the ratings category 526 results in displaying user interface element 528 corresponding to children of 526 in the hierarchy. Element 528 is associated with a filter included in the filter category indicated by 526.

In this example, elements 504, 510, 514, 520 and 528 correspond to filters represented by drop down menus. Each of the elements 504, 510, 514, 520 and 528 include a left portion which may serve as an on/off (enable/disable) mechanism for the associated filter state and a right portion which may be used in connection with displaying a drop down menu of items from which a filter value selection is made. To further illustrate, element 504 includes a left hand portion 504a with initial menu text displayed when no filter value selection has been made. The left hand portion 504a serves as an on/off (enable/disable) filter state indicator for the food category filter and represents a current filter state associated with the user interface element 504 similar to the filter state associated with the element 501 as described in connection with FIG. 4. Selection of 504b results in displaying a drop down menu of food categories.

In connection with the example 500, a user interaction, such as a selection made with a mouse or other input device, may cause the drop down menu 524 associated with 522 to be displayed. In this example, the menu 524 includes states in the U.S. and the user selects the state of Washington (WA) 524a as the filter value from the drop down menu 524.

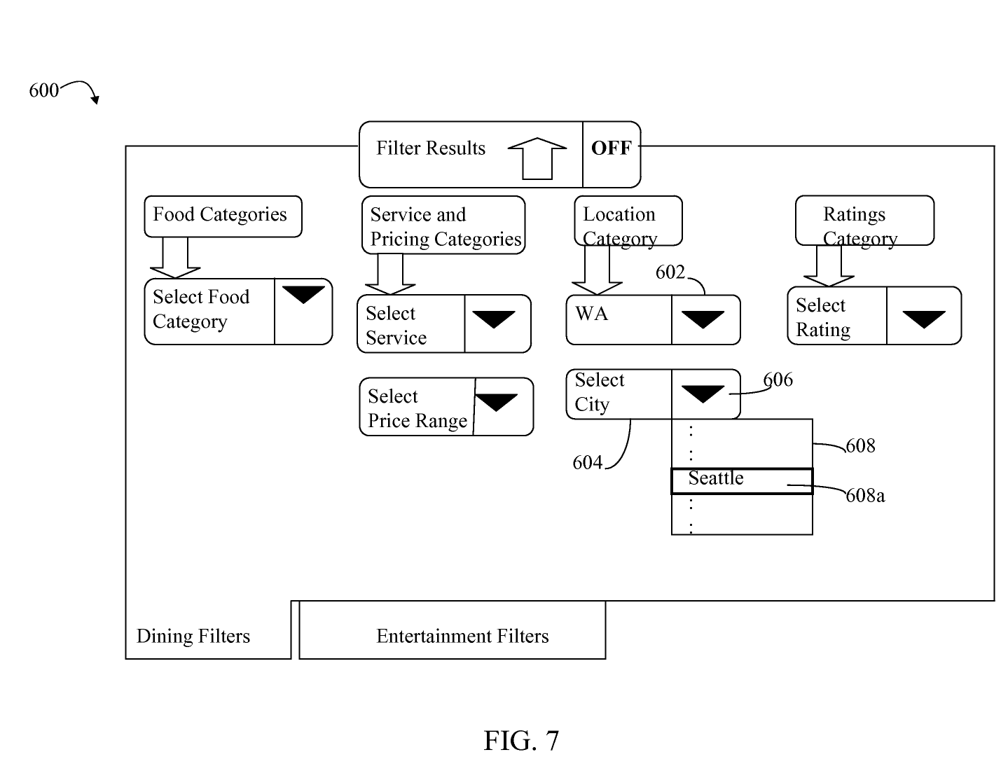

Referring to FIG. 7, shown is an example of a display that may result after selecting 524a of FIG. 6 in an embodiment using the techniques herein. Selection of 524a of FIG. 6 results in selecting a state. In response, the display may be updated as indicated by 602 to show the current filter selection. Additionally, in response to the selection of 524a, user interface element 604 is displayed so that the user may select a city within the particular state selected. The element 604 represents a child filter (e.g., city) of the parent filter (e.g., state) represented by element 602. In the foregoing, the user interface element for the child filter is displayed in response to selecting a filter value for the parent filter. In a manner similar to that as described in connection with selecting a state, the city of Seattle as indicated by 608a is selected from the city drop down menu 608.

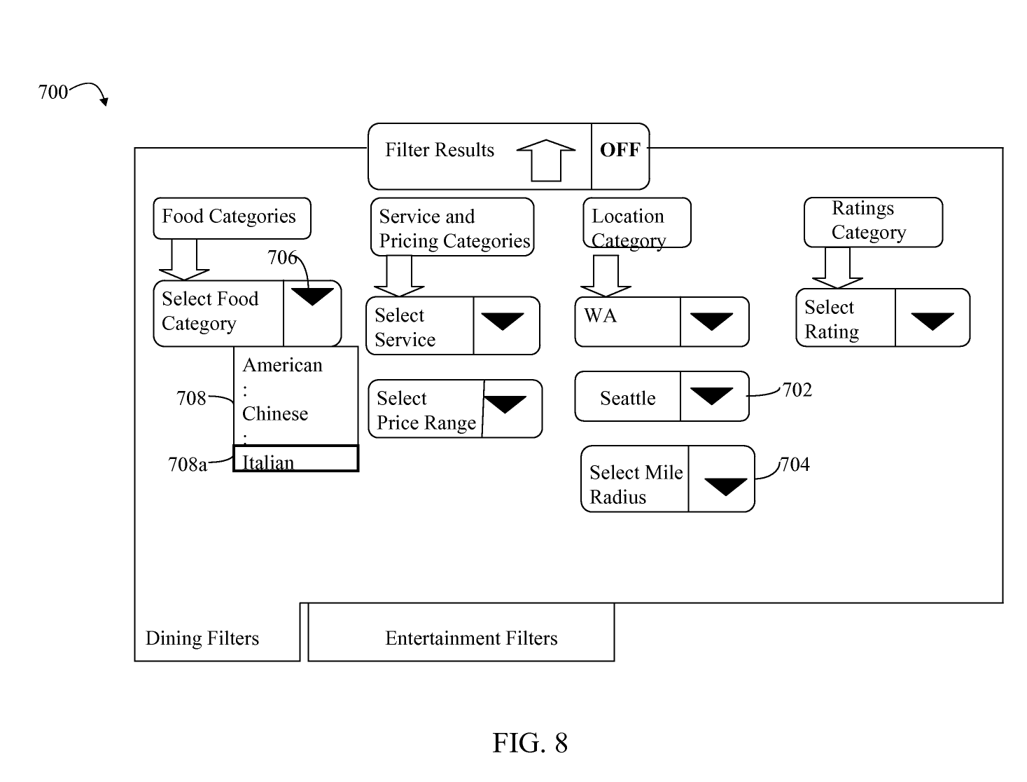

Referring to FIG. 8, shown is an example of a display that may result after selecting 608a of FIG. 7 in an embodiment using the techniques herein. In response, the display may be updated as indicated by 702 to show the current filter selection for city. Additionally, in response to the selection of 608a of FIG. 7, user interface element 704 is displayed so that the user may select a mile radius used in connection with specifying a location. In this example, the user chooses not to specify a mile radius at this time. The element 704 represents a child filter of the parent filter represented by element 702.

The user may make a selection and cause the drop down menu 708 to be displayed. A selection is then made from the menu. In this example, Italian 708a is selected from the menu as the food category filter selection or current filter value.

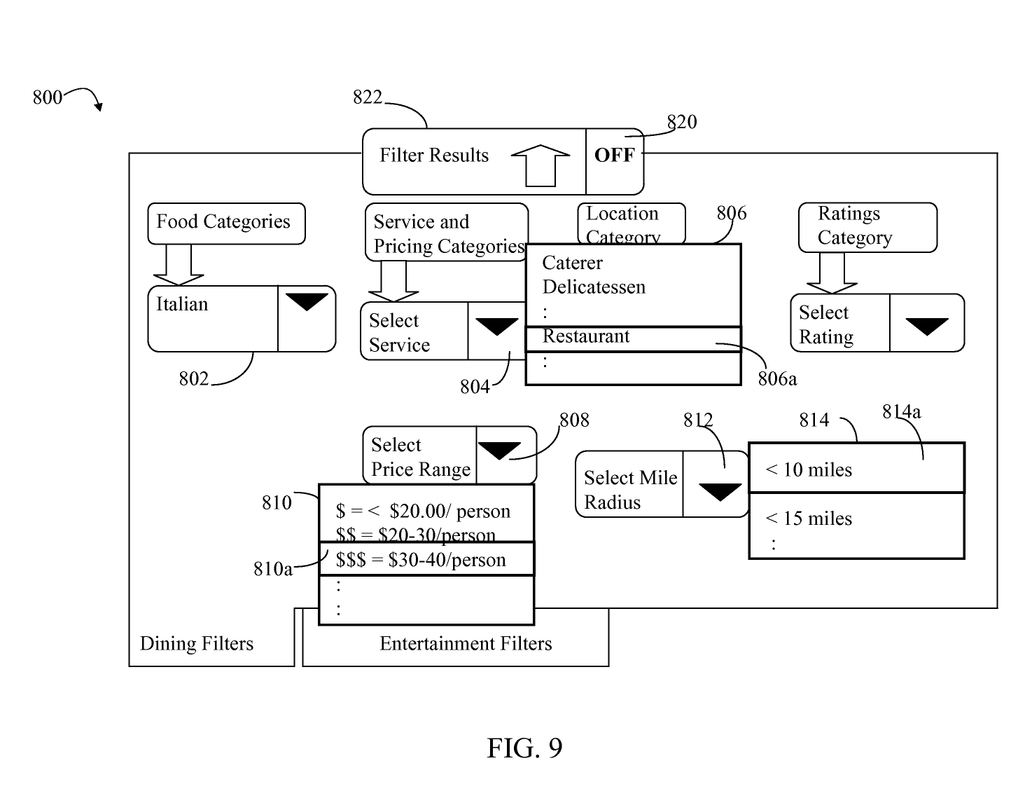

Referring to FIG. 9, shown is an example of a display that may result after selecting 708a of FIG. 8 in an embodiment using the techniques herein. Selection of 708a of FIG. 8 results in element 802 of the display being updated to show the current filter selection. As subsequent operations, the user may make additional filter selections from drop down menus. In this example, a drop down menu 806 may be displayed to select a service of restaurant as indicated by 806a. Drop down menu 810 may be displayed to select a price range as indicated by 810a. Drop down menu 814 may be displayed to select a mile radius as indicated by 814a. Additionally, a user may now select to enable the filter state indicator associated with element 822 by selecting 820.

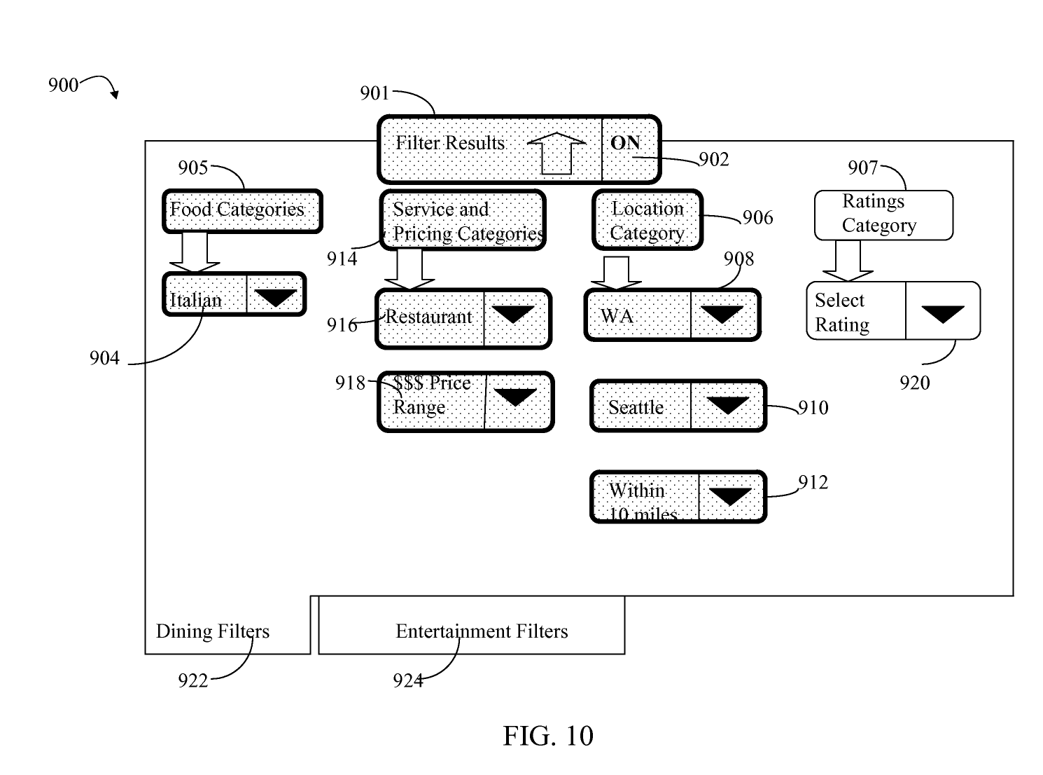

Referring to FIG. 10, shown is an example of a display that may result after making selections as described above in connection with FIG. 9 in an embodiment using the techniques herein. With reference to FIG. 9, enabling the filter state indicator of element 822 (corresponding to the root node in the hierarchy) by selecting 820 results in display of 902 with the updated filter status indicator. When the filter state indicator associated with the root node is disabled, no filters are active or included in the filtering criteria. When the filter state indicator associated with the root node is enabled, active filters are determined as those filters which have an associated filter state of on/enabled and which are not included in a path having another node at a higher level which is otherwise deactivated. This is illustrated and described in more detail below.

User interface items associated with active filters may be visually indicated and differentiated from inactive filters. An active filter may be characterized as a filter currently included in the filtering criteria and applied to a data set to produce a filtered data set. A determination regarding what filters are active is made in accordance with current settings for the filter states associated with each filter, filter category and root node as well as position of each in the hierarchy.

The visual indicator may be used to differentiate such active filters (and associated filter categories) currently applied from other inactive filters and associated filter categories. With reference to the example 900, those user interface elements associated with active filters may have a different pattern, color, and the like, than other user interface elements associated with inactive filters. Filters associated with 904, 916, 918, 908, 910 and 912 are active and included in the filtering criteria. The rating filter associated with 920 is inactive and not included in said filtering criteria. In this example, user interface elements 905, 914, 906 and 902 are displayed in a manner similar to the foregoing active filters since elements 905, 914, 906 and 902 are user interface elements associated with one or more currently active filters.

In response to turning the indicator 902 on, processing may be performed to generate data filtering criteria including those filters indicated as active, and generate a filtered data set in accordance with the data filtering criteria as described in connection with other figures herein.

As described herein, each of the filters associated with user interface elements 904, 916, 918, 908, 910, 912, and 920 has an associated filter state indicator which can be turned on/off (enabled/disabled) by selecting the left portion of each of the foregoing user interface elements. A filter value selection may be modified by selecting the right portion of one of the foregoing user interface elements causing a drop down menu to be displayed and selecting a new value therefrom.

In one embodiment, a filter state indicator may also be associated with a user interface element corresponding to a filter category. For example, a different filter state indicator may be associated with each of 905, 914, 906, and 907. The filter state indicator associated with one of 905, 914, 906 and 906 may be turned on/off by selecting/deselecting the corresponding user interface element. Additionally, as described herein, a filter state indicator may be associated with user interface element 902. In one embodiment, a filter state indicator may also be associated with each of the tabs dining filters 922 and entertainment filters 924. Filter state indicators for 922 and 924 may be modified in a variety of different ways such as, for example, making a selection using a right mouse click. Alternatively, an embodiment may choose not to have a filter state indicator associated with one or more of the user interface elements. For example, an embodiment may not have a filter state indicator associated with each of 922 and 924. Each of the foregoing filter state indicators may be individually enabled or disabled. The foregoing filter state indicators may be used in combination with the hierarchy to determine which filters are active and thus included in the filtering criteria and applied to a data set to produce a filtered data set.

The position associated with a user interface element in the hierarchy is used in determining whether a disabled filter state indicator corresponding to said user interface element causes other filters associated with other user interface elements to be omitted from the data filtering criteria (e.g., causes other filters to be determined as inactive and not applied for use in filtering the data set).

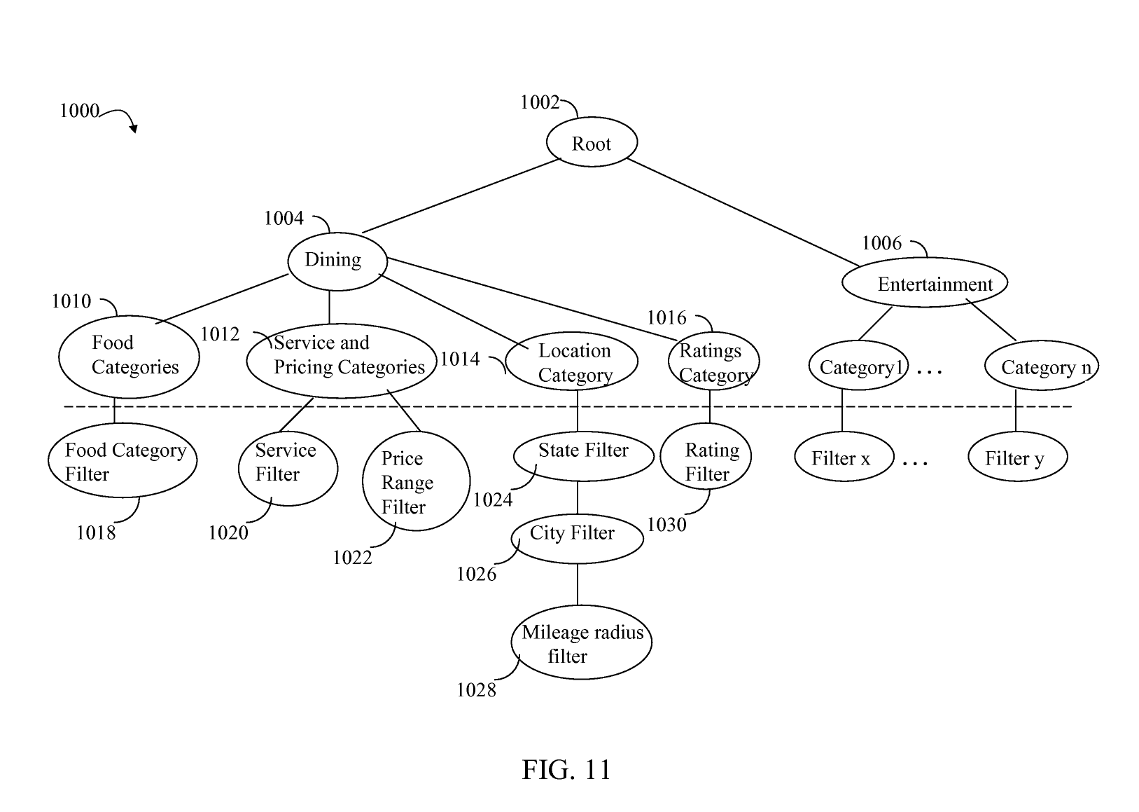

Referring to FIG. 11, shown is an example illustrating a logical representation of the candidate filters and filter categories that may be used in an embodiment with the techniques herein. The example 1000 is a representation of the hierarchy that may be associated with the filters and filter categories as illustrated in connection with the user interface displays of FIGS. 4-10. Each node in the hierarchy of 1000 may have an associated user interface element. With reference to FIG. 10, for example, the root 1002 may correspond to user interface element 901 (e.g., also 310 and 320 of FIG. 4, 401 of FIG. 5, and the like). The nodes 1004 and 1006 may correspond, respectively, to the dining tab 922 and the entertainment tab 924 of FIG. 10. Nodes 1010, 1012, 1014, and 1016 of FIG. 11 may correspond, respectively, to 905, 914, 906 and 907 of FIG. 10. Nodes 1018, 1020, 1022, and 1030 of FIG. 11 may correspond, respectively, to 904, 916, 918, and 920 of FIG. 10. Nodes 1024, 1026, and 1028 may correspond, respectively, to 908, 910 and 912 of FIG. 10.

With reference to the example 1000, a node in the hierarchy may have one or more children which are direct descendants in the level immediately beneath the node. For example, nodes 1004 and 1006 are children of 1002, and nodes 1020 and 1022 are children of 1012. Node 1002 may be referred to as the root at the top of the hierarchy and nodes at the bottom most level having no children may be referred to as leaf nodes. A node's descendants are all nodes included in paths originating from the node to a leaf node.

In one embodiment, disabling a filter state indicator associated with a node in the hierarchy causes any filters associated with the node or descendants of the node to be inactive and not included in the filtering criteria. In other words, the filter state indicator of the node, when disabled, may act as an override for any other filter state indicators associated with descendants of the node in the hierarchy. Enabling the filter state indicator associated with the node causes a filter associated with a child node to be active and thus included in the filtering criteria if the filter state indicator for the child node is enabled or on. Generally, a determination as to whether a filter is active is made by examining the filter state indicator of the filter and the filter state indicators of all nodes in the path from the root to the node corresponding to the filter (e.g., nodes at a level higher than the node and in the same path as the node). If any of the foregoing filter state indicators are off or disabled, then the filter is not active.

In accordance with the hierarchy of FIG. 11, disabling the filter state indicator of the location category 1014 causes filters associated with nodes 1024, 1026 and 1028 to be inactive and omitted from the data filtering criteria even though filter state indicators associated with 1024, 1026 and/or 1028 may be enabled because nodes 1024, 1026 and 1028 are descendants of the node 1014. In other words, the filter state indicator for 1014 in an embodiment may serve as an override when disabled or turned off to override any filters included in the location category associated with node 1014 or descendant nodes of 1014. Disabling the filter state indicator of 1026 for the city causes filters for the city and the mileage radius 1028 to be inactive but filters associated with 1024 (e.g., specifying the state) which are enabled are active and included in the filtering criteria. Disabling the filter state indicator associated with 1012 causes filters associated with 1020 and 1022 to be inactive since both of the foregoing are descendants of the node 1012.

If one or more filters are active and included in the filtering criteria, the data set is filtered in accordance with the filtering criteria. If a filter is active at a first point in time and then inactive at a second point in time, the filtered data set is updated at the second point in time to include any additional items of the data set no longer removed by the inactive filter. As an example, at a first point in time, the filters associated with state, city and mile radius (nodes 1024, 1026 and 1028) may be active. At a second point in time, the city and mile radius filters may be disabled and the state filter may be active so that the filtered data set at the second point in time is updated with respect to the first point in time to include those items previously removed due to the city and mile radius filters. Such updating may be performed automatically as described herein in an embodiment in response to changes in the filtering selection and/or filter state indicators causing a change to the active filters and thus the filtering criteria.

In the example 1000 of FIG. 11, nodes corresponding to filters are below the dashed line and nodes corresponding to filter categories are above the dashed line. The example 1000 includes a hierarchy with multiple levels of filter categories and multiple levels of filters. An embodiment may include a hierarchy having a different number of levels of filter categories and/or filters than as illustrated. The nodes in the hierarchy represent the possible or candidate data filtering criteria that may be used in connection with populating user interface elements for a particular UI configuration. In this example, the dining and entertainment categories are indicated. If a user selects a different filter category, such as to omit dining and include filters associated with the sports filter category, node 1004 and its descendants would be replaced with other nodes corresponding to the sports filter category.

It should be noted that node 1006 may include descendant nodes organized in a manner similar to that as described in connection with node 1004.

It will be appreciated that the representation of FIG. 11 may be implemented using any one or more data structures known to those skilled in the art such as, without limitation, linked lists, arrays, and the like.

What will now be described is an example of information that may be stored in connection with the nodes of the hierarchy of FIG. 11. It should be noted that additional information may be maintained and used in connection with the techniques herein than as illustrated in following figures. Also, an embodiment may store the information described in following figures for each node as part of the data structure representing the hierarchy and/or in other data structures.

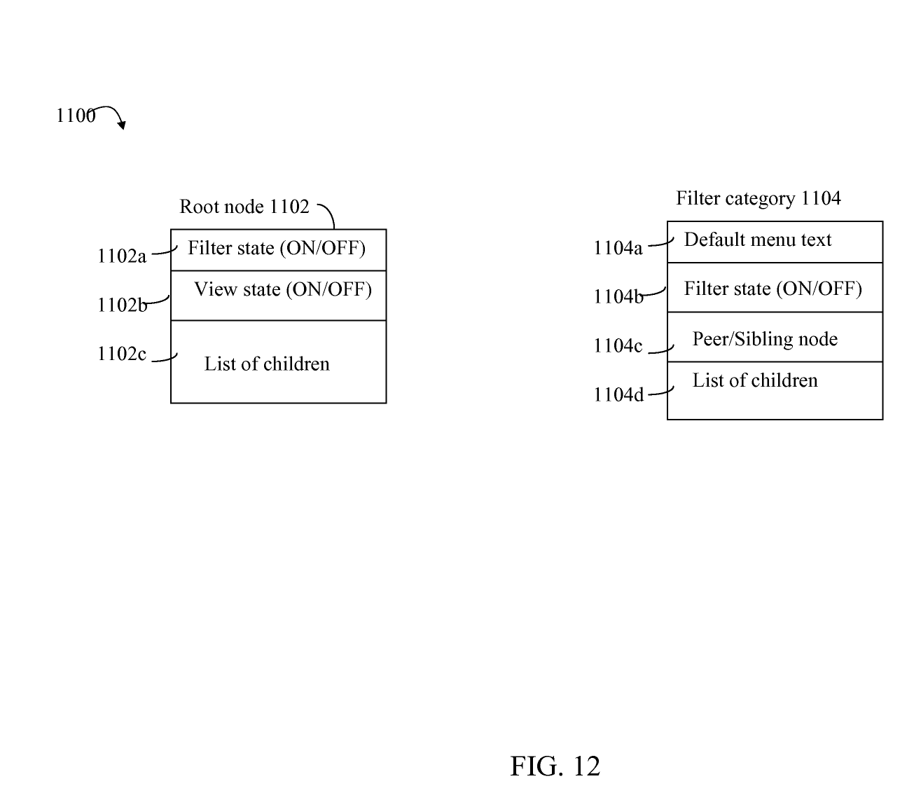

Referring to FIG. 12, shown is an example illustrating information that may stored for the root node and nodes corresponding to a filter category in an embodiment using techniques herein. Information stored for the root node 1102 may include a first indicator 1102a that is the filter state indicator for the root node, a second indicator 1102b that is the viewing state indicator for the root node, and a list 1102c of children. Element 1102c may be a pointer to the first child node of the root in the hierarchy. Element 1102b may reflect the viewing state in accordance with the selection for the right portion of the user interface element of the root node as illustrated, for example, by 314 and 324 in FIG. 4.

Information stored for each node corresponding to a filter category 1104 may include default menu text 1104a, an indicator 1104b that is the filter state indicator for the node, a pointer 1104c to the next peer or sibling node in the hierarchy, and a list 1104d of children. Element 1104c may be a pointer to the first child node in the hierarchy for the node associated with the information of 1104. Element 1104c may be a pointer to another node in the hierarchy at a same level in the hierarchy as the node associated with the information of 1104.

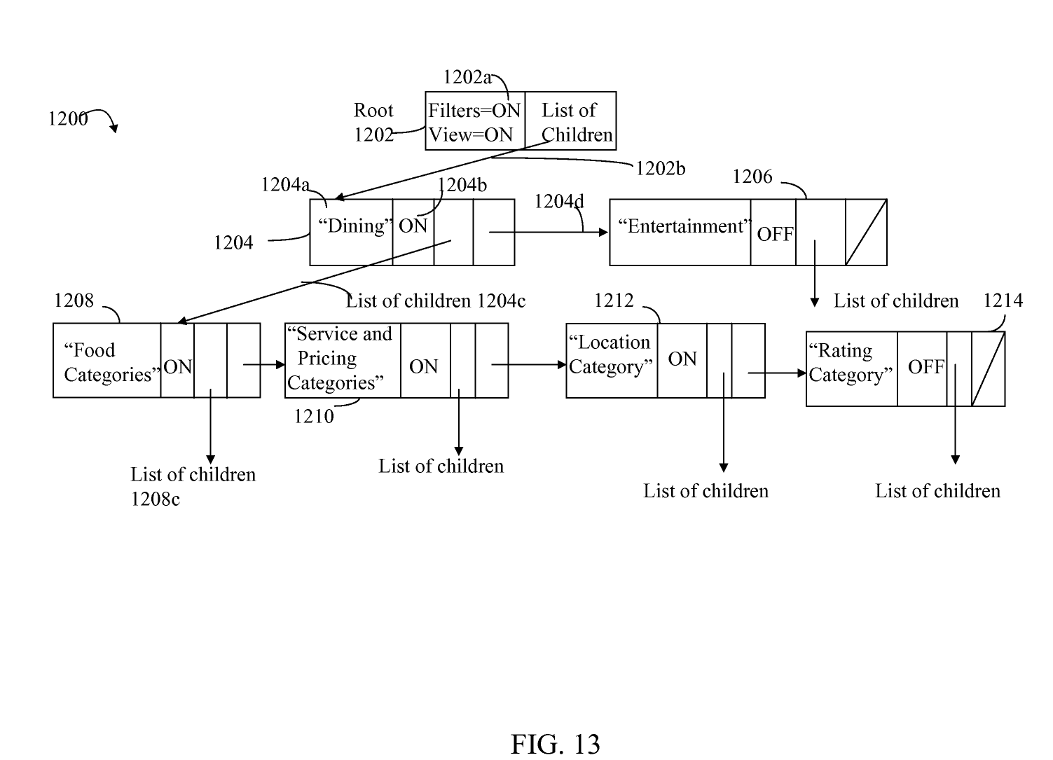

Referring to FIG. 13, shown is an example representing a structure that may be used in connection with storing the information for the root node and nodes associated with filter categories in an embodiment using the techniques herein. The example 1200 illustrates one such representation with respect to the hierarchy of FIG. 11 and with respect to the filter state indicators in accordance with the example of FIG. 10. The example 1200 includes a root node 1202 having portion 1202a with indicator settings for the filter state and view state. Element 1202b is a pointer to the first child in the list of children of the root node. Each of the nodes 1204, 1206, 1208, 1210, 1212, and 1214 correspond to filter categories. In this example, nodes 1208, 1210, 1212, and 1214 are subcategories of a main filter category represented by 1204.

As described elsewhere herein, it should be noted that an embodiment may store information associated with a node in one or more other structures than as illustrated in FIG. 13 and other figures. For example, default menu text, text for menu items, and other data used to populate displayed interface elements may stored separately from other information associated with nodes in the hierarchy and may vary with different embodiments utilizing the techniques herein.

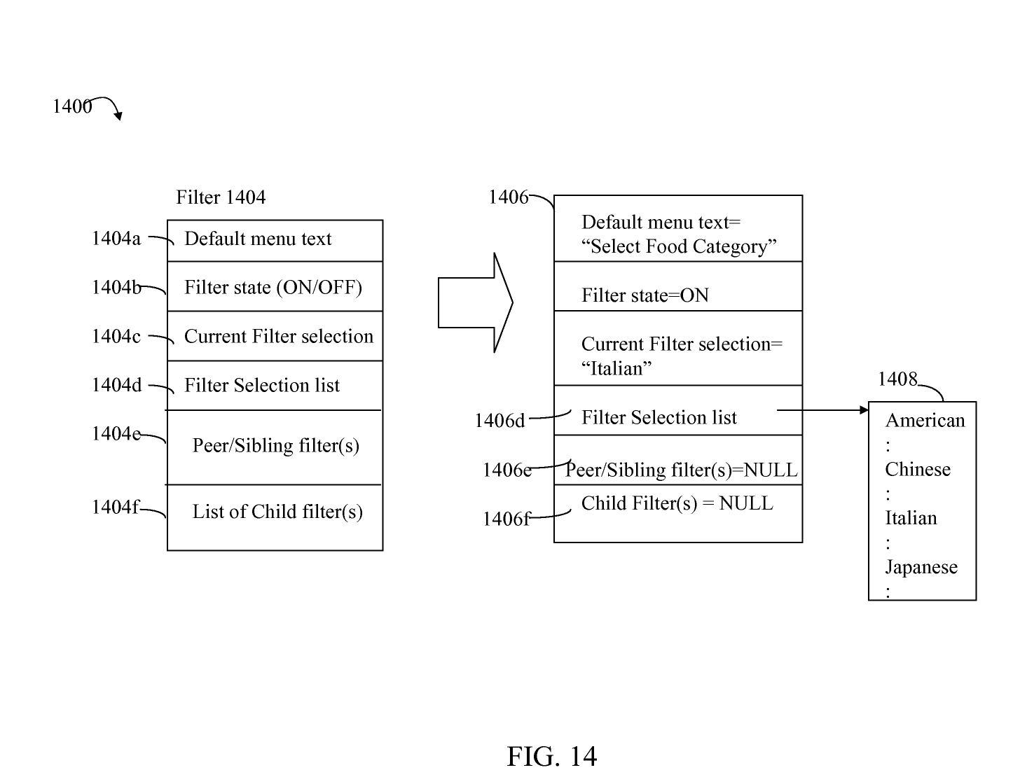

Referring to FIG. 14, shown is an example illustrating information that may stored for the nodes corresponding to a filter in an embodiment using techniques herein. Information stored for the filter node 1404 may include default menu text 1404a, an indicator 4104b that is the filter state indicator for the node, the current filter selection 1404c, the filter selection list 1404d (or a pointer or other indicator thereto), a pointer 1404e to the next peer or sibling filter node in the hierarchy, and a list 1404f of children of the node represented by 1404. Element 1404f may be a pointer to the first child node in the hierarchy for the node associated with the information of 1404. Element 1404e may be a pointer to another node in the hierarchy at a same level in the hierarchy as the node associated with the information of 1104.

Element 1406 represents the information that may be stored for the food category filter node 1018 of FIG. 11 which has no peer or sibling nodes and no children. In this example, the field 1406d may point to a list of possible menu selections for the filter or otherwise identify a mechanism used to obtain the menu items.

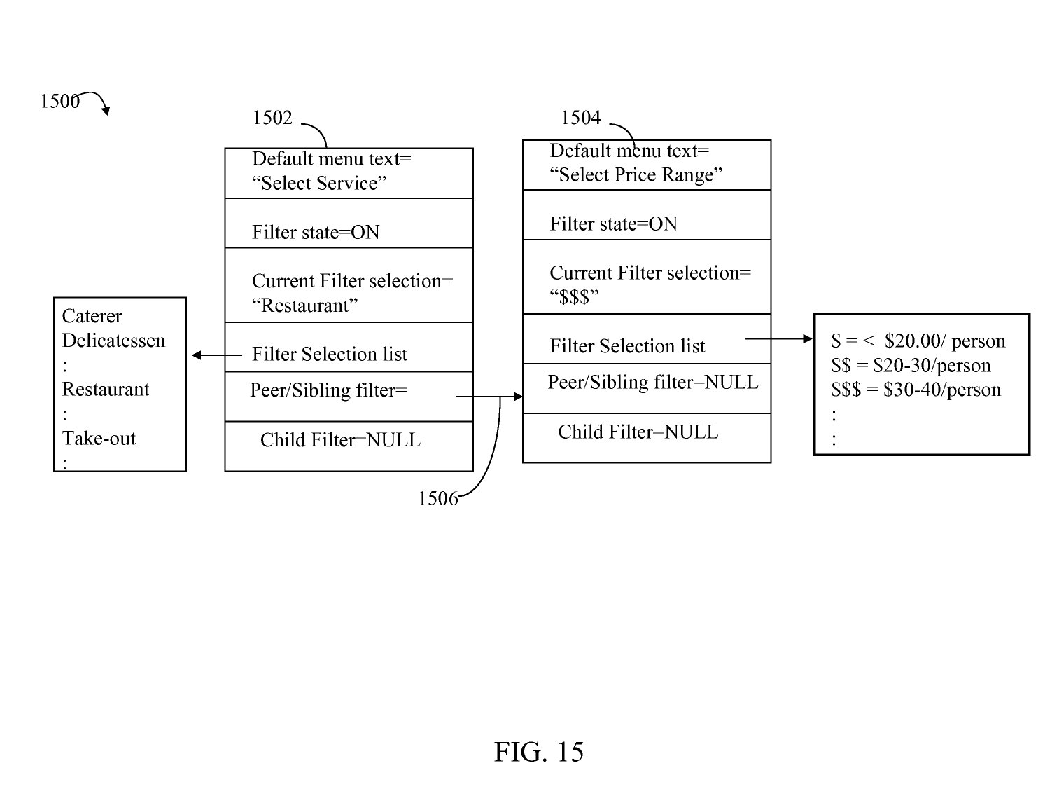

Referring to FIG. 15, shown is an example illustrating information that may be stored for nodes corresponding to the service and pricing filters in an embodiment. The example 1500 illustrates nodes which are siblings occurring at a same level in the hierarchy corresponding to peer filters having a same parent node. The element 1502 illustrates information that may be stored and associated with node 1020 of FIG. 11 and element 1504 illustrates information that may be stored and associated with node 1022 of FIG. 11.

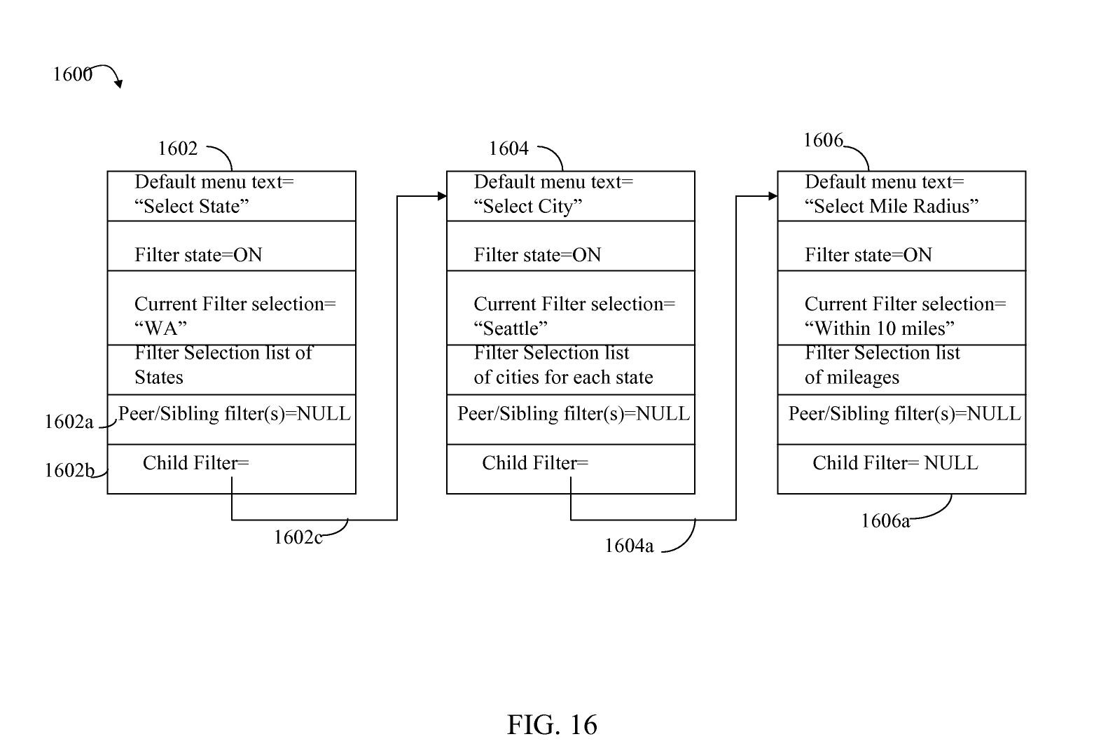

Referring to FIG. 16, shown is an example illustrating information that may be stored for nodes corresponding to the state, city and mile radius filters included in the location category filters in an embodiment. The example 1600 illustrates information that may be stored for nodes 1024, 1026, and 1028 of FIG. 11.

The structures illustrated herein are merely representative of ones that may be used in an embodiment. It will be readily apparent to those skilled in the art that the hierarchy and the information stored for nodes in the hierarchy may be included in any one or more structures and arrangements.

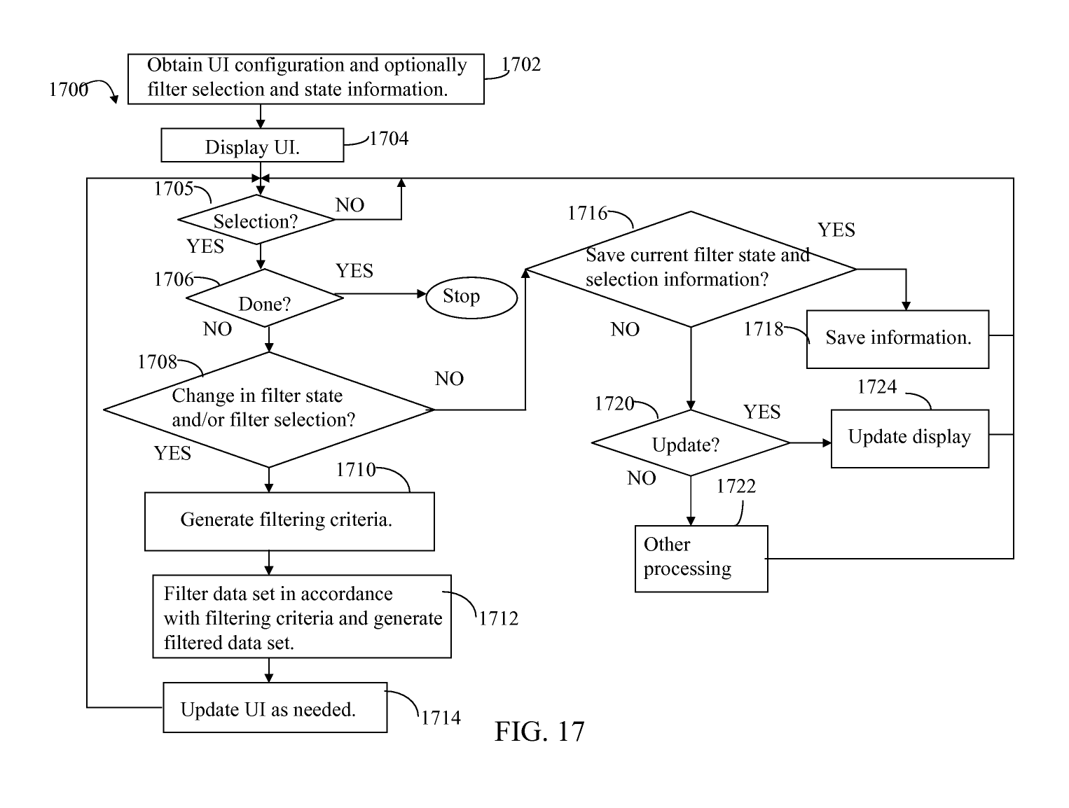

Referring to FIG. 17, shown is a flowchart of processing steps that may be performed by code executing on a computer using the techniques herein. The flowchart 1700 summarizes processing that may be performed as described elsewhere herein. At step 1702, the UI configuration, and optionally filter selection and state information, may be obtained and used an input to the UI software. As described herein, the UI configuration may indicate filter categories used in connection with populating user interface elements and determining the hierarchy of filters, filter categories, filter subcategories, and the like. At step 1704, the user interface is displayed. The user interface displayed may vary in accordance with the information used in step 1702. For example, if this is the first time the UI software is utilized, the element 310 of FIG. 4 may be displayed. As another example, if a previously saved filter selection and state information file is used, the user interface displayed may accordingly reflect this information. At step 1705, a determination as made as to whether a user selection has been made. Processing remains at step 1705 until a user selection is made. At step 1706, a determination is made as to whether the user selection is to stop processing. If so, step 1706 evaluates to yes and processing stops. Otherwise, control proceeds to step 1708 where a determination is made as to whether there has been a change in a filter state indicator and/or filter selection. If step 1708 evaluates to yes, control proceeds to step 1710 where the updated filtering criteria is generated. Step 1710 may include determining which filters are active and the current filter values for each such active filter. At step 1712, the data set is filtered in accordance with the filtering criteria and a filtered data set is generated. At step 1714, the user interface display is updated as needed. Step 1714 may include, for example, updating the display to reflect new filter selections. Control then proceeds from step 1714 to step 1705. If step 1708 evaluates to no, control proceeds to step 1716 where a determination is made as to whether the user has selected an option to save the current filter selection and stat information. If so, control proceeds to step 1718 to save the information and then processing continues with step 1705. If step 1716 evaluates to no, control proceeds to step 1720 where a determination is made as to whether to update the user interface display. Such an update may be performed, for example, in response to selecting a user interface element causing display of other elements as described in connection with FIGS. 5 and 6. If step 1720 evaluates to yes, control proceeds to step 1722 to accordingly update the display. Control then proceeds to step 1705. If step 1720 evaluates to no, control proceeds to step 1722 to perform other processing. Step 1722 includes other processing that may be performed in accordance with various user selections and interactions. From step 1722, control proceeds to step 1705.

For purposes of illustration, the techniques herein have been described in using a graph. However, other representations using various data structures may also be utilized.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for obtaining filtering criteria used to filter a data set, the method comprising:
providing a user interface including a plurality of filters having an associated hierarchy, said user interface including user interface elements corresponding to said plurality of filters and having a structure in accordance with said associated hierarchy, said associated hierarchy including at least one parent having at least one descendant;
receiving at least one selection made using said user interface; and
determining filtering criteria in accordance with said at least one selection made with the user interface, wherein a selection disabling an indicator to turn off filters associated with said at least one parent causes filters associated with said at least one descendant to not be included in said filtering criteria.

2. The method of claim 1, further comprising:
in response to selecting a user interface element corresponding to said at least one parent, displaying user interface elements for one or more filters corresponding to children of said at least one parent.

3. The method of claim 1, wherein said receiving at least one selection includes:
selecting a value for a filter associated with said at least one descendant and including said value in said filtering criteria in accordance with whether filters associated with said at least one parent and said at least one descendant are enabled.

4. The method of claim 3, wherein said value is a term selected from a menu.

5. The method of claim 1, wherein said at least one parent has a first descendant that is a child of said at least one parent and a second descendant that is a child of said first descendant, the method comprising:
receiving a selection made using said user interface to turn on filters associated with said at least one parent; and
determining whether filters associated with said first descendant and said second descendant are enabled in accordance with indicators associated with said first and said second descendants.

6. The method of claim 5, wherein said filtering criteria does not include filters associated with said second descendant when filters associated with said first descendant are disabled.

7. The method of claim 6, wherein filters associated with said second descendant are included in said filtering criteria when filters associated with said first descendant are enabled in accordance with a first indicator and when a second indicator associated with said second descendant is set to indicate that filters associated with said second descendant are enabled.

8. The method of claim 5, wherein said at least one parent has a third descendant that is a child of said at least one parent, and disabling filters associated with said at least one parent results in said filtering criteria not including filters associated with said first descendant and said third descendant and any other descendants of said at least one parent.

9. The method of claim 8, wherein enabling filters of said at least parent causes said filtering criteria to include filters associated with said first descendant that are enabled and filters associated with said third descendant that are enabled.

10. A computer readable medium comprising executable code stored thereon for filtering a data set, the computer readable medium comprising executable code for:
receiving the data set;
selecting filtering criteria using a user interface, said user interface including a plurality of filters having an associated hierarchy, said user interface having a structure in accordance with said associated hierarchy, said associated hierarchy including a parent having a first descendant that is a child of said parent;
receiving a first selection of a first user interface element corresponding to said parent;
in response to said first selection, displaying a second user interface element for a first filter corresponding to said first descendant;
receiving a second selection of an item associated with said second user interface element specifying a first filter value for said first filter; and
in response to receiving said second selection, determining said filtering criteria and filtering said data set producing a first filtered data set in accordance with said filtering criteria, wherein whether said filtering criteria includes said first filter value is determined in accordance with whether filtering is disabled for said first descendant and said parent, disabling filtering for said parent causing filtering to be disabled for descendants of said parent.

11. The computer readable medium of claim 10, further comprising executable code for:
in response to said second selection, displaying a third user interface element for another filter corresponding to a second descendant that is a child of said first descendant.

12. The computer readable medium of claim 11, further comprising executable code for:
receiving a third selection of an item associated with said third user interface element specifying a second filter value for said another filter corresponding to said second descendant; and
in response to said third selection, filtering said data set in accordance with filtering criteria including said filter value and said second filter value producing a second filtered data set.

13. The computer readable medium of claim 11, wherein said parent represents a category of filters associated with descendants of said parent in said hierarchy.

14. The computer readable medium of claim 13, wherein a first indicator is associated with said parent and indicates whether filters associated with said parent are enabled, a second indicator is associated with said first descendant indicating whether filters associated with said first descendant are enabled, and a third indicator associated with said second descendant indicating whether filters associated with said second descendant are enabled.

15. The computer readable medium of claim 14, wherein, when said first indicator has a value indicating that filters associated with said parent are disabled, filters associated with said first descendant and said second descendant are not included in said filtering criteria independent of settings of said second indicator and said third indicator, said first indicator overriding said second and said third indicators when said first indicator indicates that filters associated with said parent are disabled.

16. The computer readable medium of claim 10, wherein said at least one parent has a second descendant that is a child of said at least one parent, wherein in response to said first selection, a third user interface element for a second filter corresponding to said second descendant is displayed, and the computer readable medium further including executable code stored thereon for:
receiving a third selection of an item associated with said third user interface element specifying a second filter value for said second filter; and
in response to receiving said third selection, determining said filtering criteria and filtering said data set producing a second filtered data set in accordance with said filtering criteria, wherein whether said filtering criteria includes said second filter value is determined in accordance with whether filtering is disabled for said second descendant and said parent, and wherein if filtering is enabled for said parent and said second descendant, said second filter value is included in said filtering criteria, and if filtering is disabled for at least one of said parent and said second descendant, said second filter value is not included in said filtering criteria.

17. A computer-implemented method for obtaining filtering criteria used to filter a data set, the method comprising:
providing a user interface including a plurality of filters having an associated hierarchy, said user interface including user interface elements corresponding to said plurality of filters and having a structure in accordance with said associated hierarchy, said associated hierarchy including a parent that represents a parent filter and a first child that represents a child filter of said parent;
associating a first indicator with said first child indicating whether filters associated with said first child are enabled;
associating a second indicator with said parent indicating whether filters associated with said parent are enabled;
receiving a plurality of selections made using said user interface, said plurality of selections including specifying a first filter value for said child filter and a second filter value for said parent filter; and
determining said filtering criteria, said determining including determining whether said filtering criteria includes said first filter value and said second filter value in accordance with settings for said first indicator and said second indicator, wherein, if said second indicator indicates that filters associated with said parent are disabled, said first filter value and said second filter values are not included in said filtering criteria, said second indicator when disabled overriding said first indicator.

18. The method of claim 17, the method further comprising:
in response to a selection of a user interface element associated with a node at a first level in said hierarchy, displaying one or more other user interface elements associated with children of said node in said hierarchy.

19. The method of claim 17, wherein said user interface and said plurality of filters displayed are customized in accordance with a user interface configuration including user selected filters, and wherein a set of default filters are used in connection with said user interface configuration if no user selected filters are specified.

20. The method of claim 17, further comprising:
storing filter selection and state information at a first point in time describing filter values of current filter selections and settings of indicators associated with nodes in the hierarchy, each of said indicators being associated with a node in the hierarchy and indicating whether filters associated with said node are enabled or disabled; and
using said filter selection and state information with said user interface at a second point in time in connection with initializing said user interface at said second point in time.
